(19) United States
(12) Patent Application Publication
(10) Pub. No.: US 2007/0294636 A1
(43) Pub. Date: Dec. 20, 2007

(54) Virtual user interface apparatus, system, and method

(76) Inventor: Damon B. Sullivan, Portland, OR (US)

Correspondence Address: KACVINSKY LLC;C/O INTELLEVATE, P.O. BOX 52050, MINNEAPOLIS, MN, 55402, US

(21) Appl. No.: 11/454,252

(22) Filed: Jun. 16, 2006

(51) Int. Cl. G06F 3/02

(52) U.S. Cl. 715/810; 345/170

(57) ABSTRACT

A system, apparatus, method, and article to provide a virtual user interface are described. The apparatus may include a processor to receive a control signal from a navigation controller and to define a virtual user interface on a display device. Based on the control signal, the processor is to locate an indicator from a first location to a second location in accordance with a first navigation rule. Or, based on the control signal the processor is to locate the indicator within the second location in accordance with a second navigation rule. Other embodiments are described and claimed.

### BACKGROUND

Television (TV) display user interfaces have design lay outs to receive information from a standard TV remote control. Conventional user interfaces, however, are not easy to navigate when a user tries to enter text into an input field provided by the user interface. In conventional user interfaces, the user uses navigation arrows on the remote control to select characters representing letters of the alphabet. The user selects the navigation arrows on the remote control and points to the desired character of the alphabet. Once the arrow is pressed, a curser moves in the desired direction towards the character. The desired character may be “selected” by clicking the “select” button on the remote control. Entering characters in this manner, however, is time consuming and may require many clicks of the remote control for each character to be entered in the input field depending on which character the user wishes to enter in the input field. Accordingly, there may be a need for a user interface to reduce the number of clicks required to enter characters in an input field and to allow a user to quickly enter the characters in the input field from a remote location.

### BRIEF DESCRIPTION OF THE DRAWINGS

FIG. 1 illustrates one embodiment of a virtual user interface.

FIG. 2 illustrates one embodiment of a virtual user interface.

FIG. 3 illustrates one embodiment of a navigation controller.

FIG. 4 illustrates one embodiment of a system.

FIG. 5 illustrates one embodiment of a logic flow.

FIG. 6 illustrates one embodiment of a logic flow.

FIG. 7 illustrates one embodiment of a device.

### DETAILED DESCRIPTION

Various embodiments may be generally directed to a virtual user interface. In one embodiment, for example, the virtual user interface may include a character input field and a virtual data input device map. A processor may receive a control signal from a navigation controller and may define the virtual user interface on a display device. Based on the control signal, the processor may locate an indicator from a first location to a second location in accordance with a first navigation rule. Or, based on the control signal, the processor may locate the indicator within the second location in accordance with a second navigation rule.

A user may navigate the virtual data input device map using a pointing device. The virtual data input device map includes virtual navigation keys to navigate to one or more adjacent blocks comprising one or more virtual keys. The virtual navigation keys define a navigation area. An indicator is located in the navigation area. The indicator may comprise any moving marker or pointer that indicates a position on a computer monitor or other display device that will respond to input. In a user interface, indicator indicates where characters, symbols or text will be placed when entered. In various embodiments, the indicator may comprise a cursor such as a blinking underscore, solid rectangle, rectangle outline or focus ring, among others, for example. For the sake of brevity, the indicator is referred to as a “focus ring” hereinafter, although the embodiments are not limited in this context. The focus ring may be initially positioned and may serve as a default position. The focus ring is controlled by the navigation buttons and moves in accordance with the direction indicated by arrows located on the navigation button that is actuated. Once the focus ring is located over a desired virtual key within a block, the virtual key may be selected by actuating a control on the pointing device. For example, the virtual keys may comprise indicia representing a character or symbol, which can be placed in the character input field when the virtual is selected. The focus ring is located in a predetermined default location within the block when a corresponding navigation button is actuated. For example, when a block is selected using a virtual navigation key mapped to the navigation button on the pointing device, the focus ring may be initially positioned in the center or in proximity of the center of the block. Within the block, the focus ring may be moved in the direction corresponding the virtual navigation key or navigation button in predetermined increments. The increments may be set to one-step increments as a default. Other increments may be used to navigate within larger blocks. The virtual navigation keys correspond to navigation buttons located on the pointing device. The navigation buttons on the pointing device may be actuated to navigate within the block using the focus ring. Within the block, a desired character or symbol corresponding to a virtual key may be selected using the select button on the pointing device. When the desired character or symbol is selected, the focus ring is repositioned to its initial position in the center of the navigation area, e.g., the default state of the virtual user interface. In the manner described above, the virtual user interface minimizes the number of pointing device “clicks” required to select a virtual key to enter a corresponding character or symbol in the character input field, for example. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

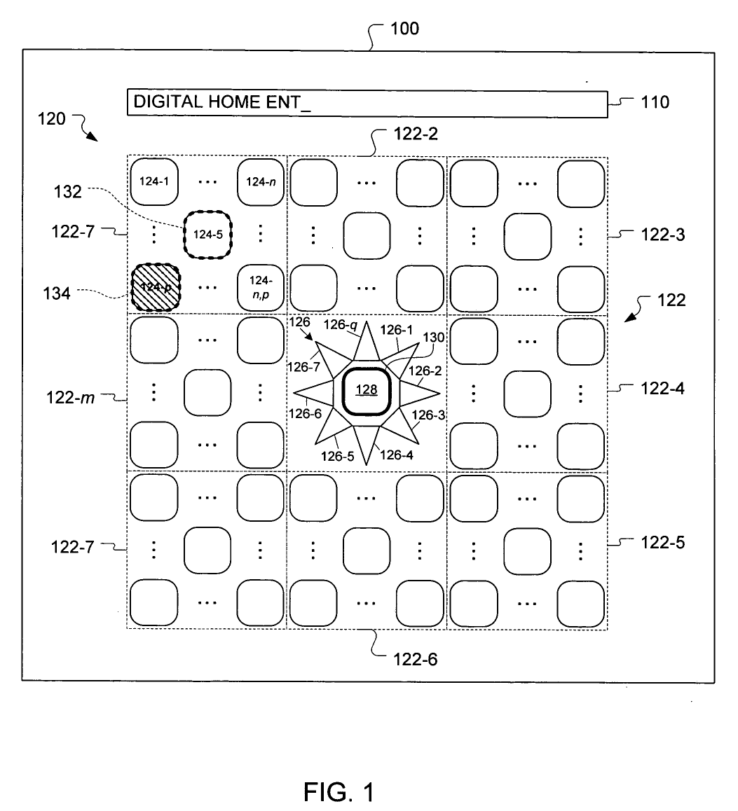

FIG. 1 illustrates one embodiment of a virtual user interface 100. The virtual user interface 100 comprises a character input field 110 and a virtual data input device map 120. The virtual interface 100 may be displayed on a display device, for example. The virtual data input device map 120 comprises one or more blocks 122, such as blocks 122-1-m, where m is any integer. Each of the blocks 122 may comprise virtual keys. For example, as shown in FIG. 1, block 122-1 comprises multiple virtual keys 124-1 to 124-n, p arranged in n columns and p rows, for example, where n and p are any integers. A block that define the size of an “n×p” block. The virtual keys 124-1-n, p in each block 122-1-m may comprise one or more indicia thereon. The virtual keys 124-1-n, p may comprise any type of indicia to represent any type of information. The indicia may comprise, for example, graphics, icons, letters, characters, symbols, and/or functions. The indicia also may be user defined, for example. In one embodiment, the indicia may comprise characters and/or symbols similar to the characters and/or symbols found in conventional keyboards. In one embodiment, the indicia may comprise characters and/or symbols of the alphabet and may be used to enter text into the character input field 110 by selecting a desired virtual key 124-1-n, p. The virtual keys 124-1-n, p also may comprise modifiers, control, alternative, shift, or other functions that are generally associated with a conventional keyboard, for example. The various embodiments described herein, however, are not limited in the context of the embodiment illustrated in FIG. 1 as the indicia on the virtual keys 124-1-n, p may represent any predefined character, symbol, modifier, control, alternative, function, or shift keys.

In one embodiment, the virtual data input device 120 may comprise one or more virtual navigation keys 126. As illustrated, in FIG. 1, q virtual navigation keys 126-1-q may be provided, where q is any integer. In the embodiment illustrated in FIG. 1, the virtual navigation keys 126-1-q are implemented as arrows, although they are not limited in this context. The virtual navigation keys 126-1-q define a navigation area 128. The navigation area 128 is the default position for the focus ring 130 (or cursor, for example). For example, with the focus ring 130 initially located in the default position in the navigation area 128, selecting virtual navigation key 126-1 moves the focus ring 130 up into the block 122-n. The initial selection of the virtual navigation key 126-1 locates the focus ring 130 in a predetermined location within the block 122-n. In one embodiment, the focus ring 130 may be located in the center of the block 122-n when a virtual navigation key 126-1 is selected. Likewise, selecting the virtual navigation key 126-2 moves the focus ring 130 to the center of the block 122-4 and so forth.

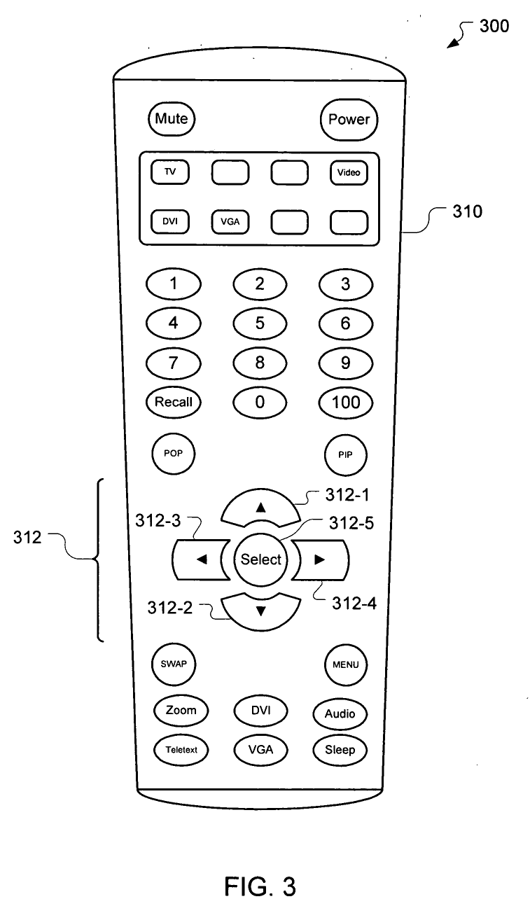

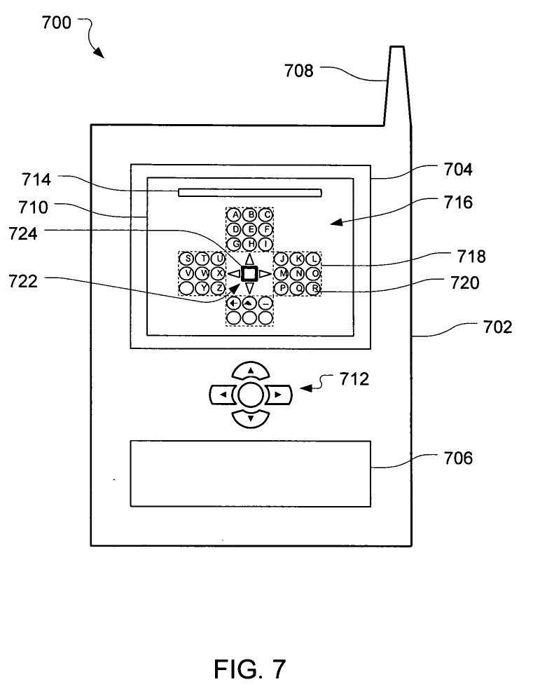

The virtual navigation keys 126 may be used to move or navigate the focus ring 130 into the blocks 122 under the control of navigation buttons located on a navigation controller. In various embodiments, the virtual user interface 100 may be located on the same device as the navigation buttons and/or the navigation controller (on-board) or may be located remotely therefrom (off-board). In one embodiment, for example, the virtual navigation keys 126 may be used to move or navigate the focus ring 130 into the blocks 122 under the control of navigation buttons 312 (FIG. 3) located on an off-board or remote type navigation controller 300 (FIG. 3). In another embodiment, for example, the virtual navigation keys 126 may be used to move or navigate the focus ring 130 into the blocks 122 under the control of an on-board type navigation controller comprising a five-way navigation button 712 (FIG. 7).

Within each of the blocks 122, the focus ring 130 may be moved up, down, left, right, or diagonally in one or multiple increments to any of the soft keys within the block using the directional virtual navigation keys 126. For example, with the focus ring 130 located in the initial default position in the navigation area 128, selecting a virtual navigation key 126-q moves the focus ring 130 to a block 122 in the direction indicated by the selected virtual navigation key 126-1-q. For example, selecting virtual navigation key 126-7 moves the focus ring 130 to a location 132 at the center of the block 122-1, where the focus ring 130 is shown in broken line. Within the block 122-1, selecting the virtual navigation key 126-5 moves the focus ring 130 to the virtual key 124-p at a desired location 134. At the desired location 134, the focus ring 130 is shown in broken line and is highlighted. In one embodiment, when the user selects the virtual key 124-p by actuating a select button 312-5 (FIG. 3) on the navigation controller 300 (FIG. 3), the character associated with the virtual key 124-p is placed in the character input field 110 and the focus ring 130 then may be repositioned in the default location in navigation area 128.

In other embodiments, for example, when the user selects any of the virtual keys 124-n, p by actuating the select button 321-5 (FIG. 3) on the navigation controller 300 (FIG. 3), the focus ring 130 may be repositioned to the center of the current block. From the navigation area 128 or from within any of the blocks 122, the focus ring 130 may be moved in single or multiple incremental steps in the direction indicated by virtual navigation keys 126-1-q. From within any of the blocks 122-1-n the focus ring 130 may be repositioned to the navigation area 128 without selecting a virtual key 124-n, p by entering an exit signal or other similar control signal from the navigation controller 300. The embodiments, however, are not limited to the elements or in the context shown or described in FIG. 1.

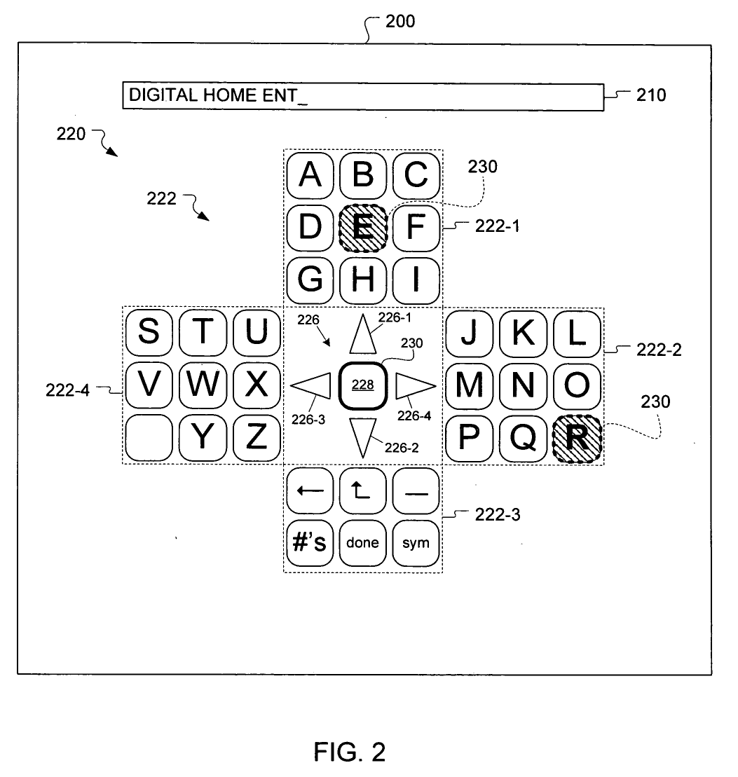

FIG. 2 illustrates one embodiment of a virtual user interface 200. The virtual user interface 200 comprises a character input field 210 and a virtual data input device map 220. The virtual interface 200 may be displayed on a display device, for example. In one embodiment, the virtual interface 200 may be displayed on a display device, for example. In the embodiment illustrated in FIGS. 1 and 2, the user is in the process of entering the string “DIGITAL HOME ENTERTAINMENT” of which, the portion “DIGITAL HOME ENT” has been entered in the character input field 110 by the user. Accordingly, the example described below follows the process for entering the next two letters in the string, namely “E” and “R,” in character input field 210. The virtual data input device 220 comprises one or more blocks 222, such as blocks 222-1-4. Each of the blocks 222 may comprise indicia as previously discussed with reference to FIG. 1 (e.g., graphics, icons, letters, characters, symbols, and/or functions). The indicia may represent any type of information. In the embodiment illustrated in FIG. 2, the virtual keys comprise indicia representing characters and/or symbols of the alphabet to enable a user to enter text in the character input field 210. For example, as shown in FIG. 2, block 222-1 comprises the virtual keys that include a first group of characters of the alphabet A-I. Block 222-2 comprises the next group of characters of the alphabet J-R, and block 222-4 comprises the final block of characters of the alphabet S-Z. In addition, block 222-3 may comprise various other characters, modifiers, control, alternative, function, or shift keys consistent with conventional keyboards, for example.

In one embodiment, the virtual data input device 220 may comprise one or more virtual navigation keys 226. As illustrated in FIG. 2, the virtual data input device 220 comprises four directional arrow type of virtual navigation keys 226-1-4 to move a focus ring 230 in the direction indicated thereon. For example, selecting the virtual navigation key 226-1 moves the focus ring 230 upward to block 221-1, selecting the virtual navigation key 226-2 moves the focus ring 230 downward to block 222-3, selecting the virtual navigation key 226-3 moves the focus ring 230 leftward to block 222-4, and selecting the virtual navigation key 226-4 moves the focus ring 230 rightward 222-2. The virtual navigation keys 226-1-4 define a navigation area 228. The navigation area 228 is the default position for the focus ring 230 (or cursor, for example).

The virtual navigation keys 226 are used to move or navigate the focus ring 230 from the navigation area 228 to any one of the blocks 222 and to any of the virtual keys within the block 222 as may be desired by the user. For example, with the focus ring 230 located in the default initial position in the navigation area 228, selecting virtual navigation key 226-1 moves the focus ring 230 upward into the block 222-1. The initial selection of the virtual navigation key 226-1 places the focus ring 230 in the center of the block 222-1. In the illustrated embodiment, selecting the virtual navigation key 226-1 locates the focus ring 230 in the position occupied by the virtual key “E” in the center of the block 222-1, shown highlighted. Likewise, selecting the virtual navigation key 226-3 locates the focus ring 230 in the “W” position in the center of the block 222-4, selecting the virtual navigation key 226-4 locates the focus ring 230 in “N” position in the center of the block 222-2, and so forth. Selecting the virtual navigation key 226-2 locates the focus ring 230 to either one of the center soft keys [symbol] or “done” based on the particular configuration of the virtual data input device 220. Within each of the blocks 222, the focus ring 230 may be moved upward, downward, leftward, or rightward in one or multiple increments to any of the virtual keys within the block 222 using the directional virtual navigation keys 226.

With the focus ring 230 located in the initial default position within the navigation area 228, selecting the upward virtual navigation key 226-1 locates the focus ring 230 over the virtual key “E,” shown with the focus ring 230 in broken line and highlighted. If the user selects the virtual key “E” that character is entered in the character input field 210 and the focus ring 230 is repositioned to the navigation area 228. To select the next virtual key in the sequence “R,” the user selects the rightward virtual navigation key 226-4 to locate the focus ring over the virtual key “N,” and then may select either the rightward virtual navigation key 226-4 and the downward navigation key 226-2 to locate the focus ring 230 over the virtual key “R,” where the focus ring 230 is shown in broken line. Alternatively, from the virtual key “N,” the user may select the rightward virtual navigation key 226-4 and the downward virtual navigation key 226-2 to locate the focus ring 230 over the virtual navigation key “R.” Once the focus ring 230 is located over the desired virtual key “R,” selecting the virtual key “R,” places the character “R” in the character input field 220 and, in one embodiment, repositions the focus ring 230 to the navigation area 228. As previously discussed, the virtual keys within the various blocks 222 may be selected by actuating the select button 312-5 (FIG. 3) on the navigation controller 300 (FIG. 300). In other embodiments, for example, selecting the highlighted virtual key by actuating the select button 312-5 on the navigation controller 300, may reposition the focus ring 230 within the current block. From the navigation area 228 or from within any of the blocks 222, the focus ring 230 may be moved in single or multiple incremental steps along any of the directions indicated by virtual navigation keys 226-1-4. In the example illustrated above, the increment is a one-step increment. Once the focus ring 230 is located within a predetermined location within the block 222, each additional click of the virtual navigation keys 226-1-4 moves the focus ring 230 one position in the direction indicated by the selected virtual navigation key 226. From within any of the blocks 222-1-4 the focus ring 230 may be repositioned to the navigation area 228 without selecting a virtual key by entering an exit signal or other similar control signal from the navigation controller 300 (FIG. 3). The embodiments, however, are not limited to the elements or in the context shown or described in FIG. 2, as multiple step increments may be defined in certain embodiments comprising large sized blocks 222, for example.

FIG. 3 illustrates one embodiment of a navigation controller 300. In one embodiment, the navigation controller 300 may be a pointing device 310. The pointing device 310 may be any computer hardware component (specifically human interface device) that allows a user to input spatial (i.e., continuous and multi-dimensional) data into a computer. Many systems such as computer aided design (CAD), graphical user interfaces (GUI), and televisions and monitors allow the user to control and provide data to the computer or television using physical gestures—point, click, and drag—typically by moving wired or wireless pointing device such as a mouse, trackball, touchpad, pointing stick, light pen, joystick, head pointer, eye tracking device, digitizing tablet, data glove, remote controller, among others. Movements of the pointing device 310 are echoed on a display device by movements of a pointer, cursor, focus ring, or other visual indicators displayed on the display device.

In the illustrated embodiment, the pointing device 310 is a conventional remote control unit used to interact with audio/visual devices such as televisions, monitors, cable boxes, digital video disc (DVD) player, compact disc (CD) players, digital video recorders (DVR), video games, digital video camera, and/or digital still camera, among others, for example. The pointing device 310 comprises navigation buttons 312. In one embodiment, the navigation buttons 312 comprise an upward navigation button 312-1, a downward navigation button 312-2, a leftward navigation button 312-3, and a rightward navigation button 312-4. The navigation buttons 312 also may comprise a select button 312-5 to execute a particular function. In the illustrated embodiment, actuations of the navigation buttons 312 are correlated to the virtual navigation keys 226 and are echoed on a display device by the movements of the focus ring 230, for example. The pointing device 310 may be a wireless remote that operates on wireless principles employing infra-red (IR) energy or radio frequency (RF) energy. In other embodiments, the pointing device 310 may be hard wired to the display device, for example. The embodiments, however, are not limited to the elements or in the context shown or described in FIG. 3.

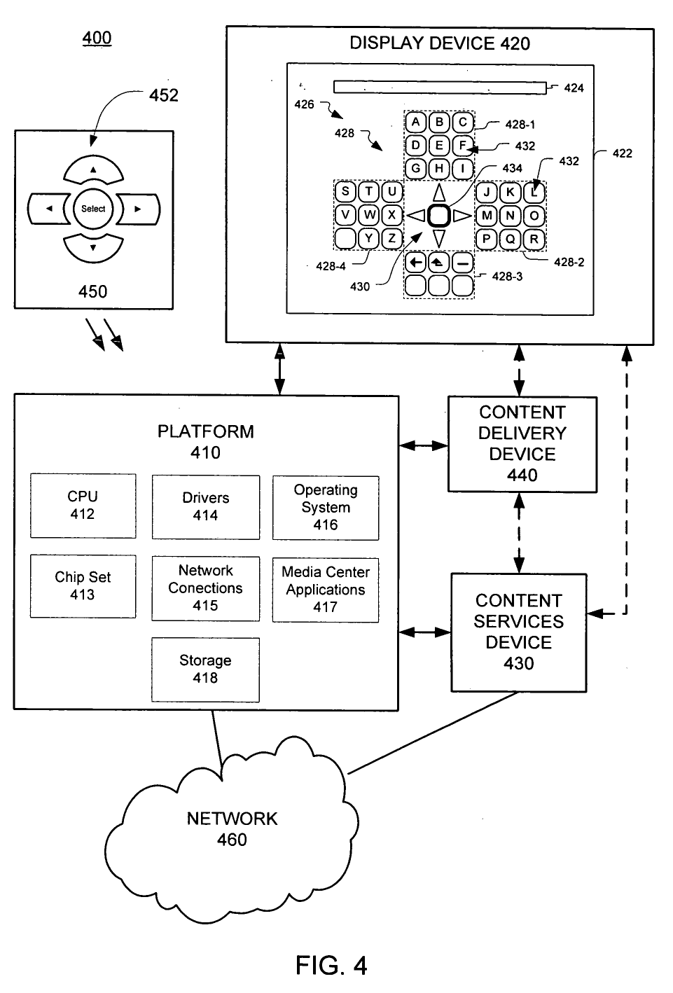

FIG. 4 illustrates one embodiment of a system 400. In one embodiment, the system 400 may be a digital home entertainment system although system 400 is not limited in this context. In one embodiment, the system 400 comprises a platform 410 coupled to a display device 420. In one embodiment, the platform 410 may comprise or may be implemented as a media platform such as the Viiv™ media platform made by Intel® Corporation. In one embodiment, the platform may receive content from a content device such as a content services device 430 or a content delivery device 440 or other similar content source. A content services device 430 may be coupled to the platform 410 and/or to the display device 420. The platform 410 and/or the content services device 430 may be coupled to a network 460 to communicate (e.g., send and/or receive) media information to and from the network 460. A content delivery device 440 also may be coupled to the platform 410 and/or to the display device 420. In various embodiments, the platform 410 and the content services device 430 may be integrated, or the platform 410 and the content delivery device 440 may integrated, or the platform 410, the content services device 430, and the content delivery device 440 may be integrated, for example. In various embodiments, the platform 410 and the display device 420 may be an integrated unit and the display device, or the content service device 430 may be integrated, or the display device 420 and the content delivery device 440 may integrated. A navigation controller 450 comprising one or more navigation buttons 452 may be used to interact with either the platform 410 or the display device 420, and/or both, for example.

In one embodiment, the platform 410 may comprise a CPU 412, a chip set 413, one or more drivers 414, one or more network connections 415, an operating system 416, and/or a media center application 417 comprising one or more software applications, for example. The platform 410 also may comprise storage 418.

In one embodiment, the CPU 412 may comprise one or more processors such as dual-core processors. Examples of dual-core processors include the Pentium® D processor and the Pentium® processor Extreme Edition both made by Intel® Corporation, which may be referred to as the Intel Core Duo processors, for example.

In one embodiment, the chip set 413 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, the drivers 414 may comprise the Quick Resume Technology Drivers made by Intel® to enable users to instantly turn on and off the platform 410 like a television with the touch of a button after initial boot-up, when enabled, for example. In addition the chip set 413 may comprise hardware and/or software support for 5.1 surround sound audio and/or high definition 7.1 surround sound audio, for example. The drivers 414 may include a graphics driver for integrated graphics platforms. In one embodiment, the graphics driver may comprise a peripheral component interconnect (PCI) Express graphics card.

In one embodiment, the network connections 415 may comprise the PRO/1000 PM or PRO/100 VE/VM network connection, both made by Intel® Corporation.

In one embodiment, the operating system 416 may comprise the Windows® XP Media Center made by Microsoft® Corporation. In one embodiment, the one or more media center applications 417 may comprise a media shell to enable users to interact with content using the navigation controller 450 (e.g., remote control) from a distance of about 10-feet away from the platform 410 or the display device 420, for example. In one embodiment, the media shell may be referred to as a “10-feet user interface,” for example. In addition, the one or more media center applications 417 may comprise the Quick Resume Technology made by Intel®, which allows instant on/off functionality and may allow the platform 410 to stream content to media adaptors or other content services devices 430 or content delivery devices 440 when the platform is turned “off.”

In one embodiment, the storage 418 may comprise the Matrix Storage technology made by Intel® to increase the storage performance enhanced protection for valuable digital media when multiple hard drives are included, for example.

In one embodiment, the display device 420 may comprise any television type monitor or display. The display device 420 may comprise, for example, a computer display screen, video monitor, television-like device, and/or a television. The display device 420 may be digital and/or analog.

In various embodiments, the content services device 430 may comprise a cable television box, personal computer, network, telephone, Internet enabled devices or appliance capable of delivering digital information and/or content, and any other similar device capable of unidirectionally or bidirectionally communicating content between content providers and the platform 410 and/display device 420, via the network 460. It will be appreciated that the content may be communicated unidirectionally and/or bidirectionally to and from any one of the components in the system 400 and a content provider via the network 460. Examples of content may include any media information including, for example, video, music, and gaming information. Content services device 430 receives content such as cable television programming including media information, digital information, and/or other content. Examples of content providers may include any cable or satellite television or radio content providers and may include, for example, ESPN, Movielink, and MTV Overdrive for video; Napster, AOL and Tiscali for music; and Gametap, Square Enix and T-Online for gaming.

In various embodiments, the content delivery device 440 may comprise a DVD player, CD player, DVR, video game, digital video camera, digital still camera, and/or MP3 (MPEG-1 Audio Layer 3 where MPEG stands for Moving Pictures Experts Group) player, among others, for example.

The platform 410 may receive content from the network 460 directly or via the content services device 430. The platform 410 may receive content from the content delivery device 440. Under the control of one or more software applications, such as the media center application 417, the platform 410 displays the virtual user interface 422 (e.g., the virtual user interface 100, 200) on the display device 420. The virtual user interface 422 comprises a character input field 424 (e.g., character input field 110, 210) and a virtual data input device map 426 (e.g., virtual data input device map 120, 220). The virtual data input device map 426 comprises one or more blocks 428-1-4 (e.g., blocks 122, 222) and one more virtual navigation keys 430 (e.g., virtual navigation keys 126, 226). Each of the blocks 428 comprises one or more virtual keys 432, for example. Each of the blocks 428 may comprise indicia as previously discussed with reference to FIGS. 1 and 2 (e.g., graphics, icons, letters, characters, symbols, and/or functions). The indicia may represent any type of information. In the embodiment illustrated in FIG. 4, the virtual keys 432 comprise indicia representing characters and/or symbols of the alphabet to enable a user to enter text in the character input field 424. A focus ring 434 (e.g., focus ring 130, 230) is provided to navigate to and reference the desired virtual keys 432.

In one embodiment, the platform 410 may receive control signals from the navigation controller 450 (e.g., navigation controller 300). The navigation buttons 452 (e.g., navigation buttons 312) may be used to interact with the virtual user interface 422. For example, under the control of software applications, e.g., the media center applications 417, the navigation buttons 452 located on the navigation controller 450 may be mapped to the virtual navigation keys 430 displayed as a portion of the virtual data input device map 426.

Thus, information associated with the virtual keys 432 may be entered in the character input field 424 as previously described with reference to FIGS. 1 and 2. For example, the focus ring 434 may be provided in a default initial location. In one embodiment, the focus ring 434 is generally provided approximately in the center of the area defined by the virtual navigation keys 430. Actuating one of the upward/downward/leftward/rightward and/or diagonal navigation buttons 452 located on the navigation controller 450 moves the focus ring in a corresponding upward/downward/leftward/rightward and/or diagonal direction. In response to the actuation of the left navigation button the focus ring 434 moves from the default location to the center of the block 428-4 located to the left of the focus ring 434 along the direction indicated by the corresponding left virtual navigation button 430. From within the block 428-4, further actuating any of the navigation buttons 452 moves the focus ring 434 in the corresponding direction in single or multiple steps depending on the particular implementation. Once the focus ring 434 is located at the desired virtual key, actuating the “select” button on the navigation controller 450 places the corresponding character or symbol in the character input field 424 and the focus ring 434 is repositioned in the initial default location.

In various embodiments, the system 400 may be implemented as a wireless system, a wired system, or a combination of both. When implemented as a wireless system, the system 400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, the system 400 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

The platform 410 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. From within any of the blocks 428-1-4 the focus ring 434 may be repositioned to the navigation area without selecting a virtual key 432 by entering an exit signal or other similar control signal from the navigation controller 450. The embodiments, however, are not limited to the elements or in the context shown or described in FIG. 4.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

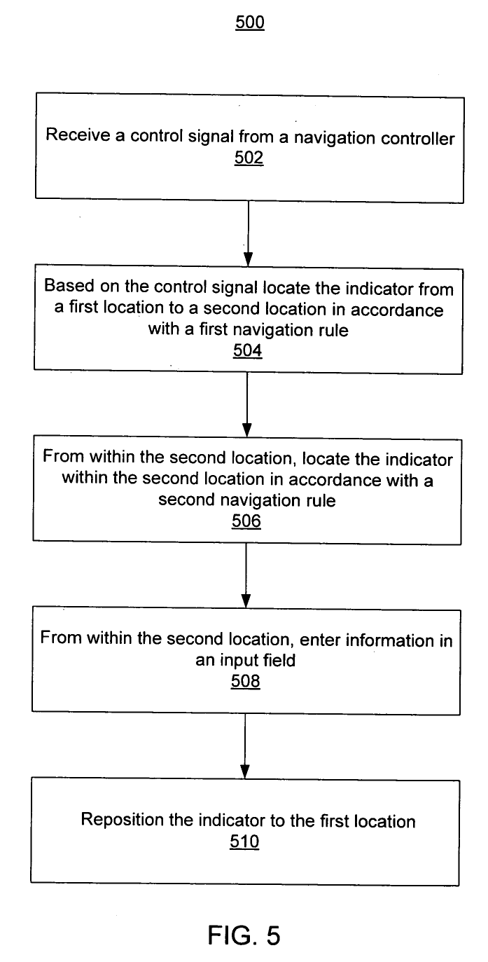

FIG. 5 illustrates one embodiment of a logic flow 500. The logic flow 500 may be representative of the operations executed by one or more embodiments described herein, for example, the operations executed by the system 400. In one embodiment, the logic flow 500 may be representative of the operations executed by a processor (e.g., the CPU 412) under the control of one more software applications (e.g., media center applications 417). The platform 410 comprising the processor 412 provides the necessary information to the display device 420 to map the virtual user interface 422 on the display device 420. The platform 410 locates an indicator (e.g., the focus ring 434) in a first location, which may be a default location. As shown in logic flow 500, the processor 412 receives 502 a control signal from a navigation controller (e.g., the navigation controller 450). Based on the control signal, the processor 412 locates 504 the indicator from a first location to a second location in accordance with a first navigation rule. From within the second location, the processor 412 locates 506 the indicator within the second location in accordance with a second navigation rule. From within the second location, the processor 412 may enter 508 information in an input field and may reposition 510 the indicator to the first location. In one embodiment, from within the second location, the processor 412 may reposition the first location without entering any information in the input field when it receives a suitable signal from the navigation controller. The embodiments, however, are not limited to the elements or in the context shown or described in FIG. 5.

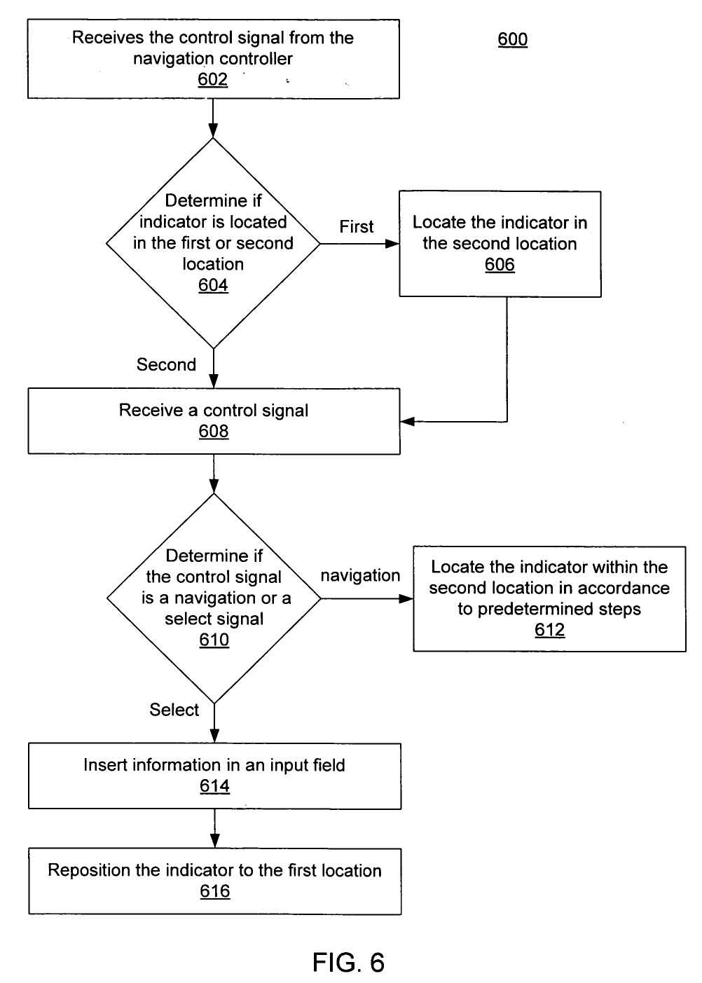

FIG. 6 illustrates one embodiment of a logic flow 600. The logic flow 600 may be representative of the operations executed by one or more embodiments described herein, for example, the operations executed by the system 400. In one embodiment, the logic flow 600 may be representative of the operations executed by the processor (e.g., the CPU 412) under the control of one more software applications (e.g., media center applications 417) in accordance with the first navigation rule. Accordingly, when the processor 412 receives 602 the control signal from the navigation controller 450, the processor 412 determines 604 whether the indicator (e.g., focus ring 434) is located in the first location, e.g., the initial default location, or whether the indicator is located within a second location, e.g., within a block. If the indicator is located in the first location, the flow proceeds along the “first” path and the processor 412 locates 606 the indicator in the second location, e.g., within the block 428, located in the navigation direction provided by the control signal and locates the indicator in a predetermined default location within the block 428. In one embodiment, the predetermined default position in the second location may be the center of the block 428. The embodiments are not limited in this context.

In accordance with a second navigation rule, when the indicator is located within the second location, the flow proceeds along the “second” path in accordance with a second navigation rule. Accordingly, now when the platform receives 608 a control signal it determines 610 whether the control signal is a navigation signal or a select signal. If the control signal is a navigation signal, the flow continues along the “navigation” path and the platform 410 locates 612 the indicator within the second location in accordance to predetermined steps. For example, if the step=1, the indicator is moved upwardly/downwardly one row or leftwardly/rightwardly one column from the current position of the indicator. If the step=2, the indicator is moved upwardly/downwardly two rows or leftwardly/rightwarldy two columns from the current position of the indicator, and so forth. If the indicator is at the end of a row or column, in one embodiment, the indicator wraps around the corresponding row or column. If the control signal is a select signal, the flow proceeds along “select” path and the processor 412 inserts 614 information (e.g., character or symbol associated with the virtual key that the indicator is currently located on) in an input field (e.g., text input field 424) and repositions 616 the indicator to the first location. From within the second location, the indicator may be repositioned to the first location without selecting any information such as a character or symbol, for example, when it receives a suitable signal or other similar control signal from the navigation controller 450. The embodiments, however, are not limited to the elements or in the context shown or described in FIG. 6.

FIG. 7 illustrates one embodiment of a device 700. In one embodiment, for example, the device 700 may comprise a communication system. In various embodiments, the device 700 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, the device 700 may be implemented as part of a wired communication system, a wireless communication system, or a combination of both. In one embodiment, for example, the device 700 may be implemented as a mobile computing device having wireless capabilities. A mobile computing device may refer to any device having a processing system and a mobile power source or supply, such as one or more batteries, for example. Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, the device 700 may comprise a housing 702, a display 704, an input/output (I/O) device 706, and an antenna 708. The device 700 also may comprise a five-way navigation button 712. The I/O device 706 may comprise a suitable keyboard, a microphone, and/or a speaker, for example. The display 704 may comprise any suitable display unit for displaying information appropriate for a mobile computing device. The I/O device 706 may comprise any suitable I/O device for entering information into a mobile computing device. Examples for I/O device 706 may include an alphanumeric keyboard, a numeric keypad, a touch pad, input keys, buttons, switches, rocker switches, voice recognition device and software, and so forth. Information also may be entered into the device 700 by way of microphone. Such information may be digitized by a voice recognition device. The embodiments are not limited in this context.

The device 700 may comprise a virtual user interface 710 that may be displayed on the display 704 similar to the virtual user interfaces 100, 200 discussed herein. As previously discussed, the virtual user interface 710 may comprise a character input field 714 and a virtual data input device map 716. The virtual user interface 710 may be displayed on the display 704 located on the device 700, for example. The virtual data input device map 716 may comprise one or more blocks 718. Each of the blocks 718 may comprise virtual keys 720 arranged in columns and rows, for example. The virtual keys 720 in each of the blocks 718 may comprise one or more indicia thereon. The virtual keys 720 may comprise any type of indicia to represent any type of information. The indicia may comprise, for example, graphics, icons, letters, characters, symbols, and/or functions. The indicia also may be user defined, for example. In one embodiment, the indicia may comprise characters and/or symbols similar to the characters and/or symbols found in conventional keyboards. In one embodiment, the indicia may comprise characters and/or symbols of the alphabet and may be used to enter text into the character input field by selecting a desired virtual key. The virtual keys 720 also may comprise modifiers, control, alternative, shift, or other functions that are generally associated with a conventional keyboard, for example. The various embodiments described herein, however, are not limited in context to the embodiment illustrated in FIG. 7 as the indicia associated with the virtual keys 720 may represent any predefined character, symbol, modifier, control, alternative, function, or shift keys.

In one embodiment, the virtual data input device map 716 may comprise one or more virtual navigation keys 722. In the embodiment illustrated in FIG. 7, the virtual navigation keys 722 are implemented as arrows, although they are not limited in this context. The virtual navigation keys 722 define a navigation area, which may be a default position for the focus ring 724 (or cursor, for example).

The virtual navigation keys 722 may be mapped with the five-way navigation button 712, for example. The virtual navigation keys 722 may be used to move or navigate the focus ring 724 into the blocks 718 under the control of the navigation buttons 712 located on the device 700. In various embodiments, the virtual user interface 710 and the navigation buttons 712 may be located on the device 700. In one embodiment, the virtual navigation keys 722 may be used to move or navigate the focus ring 724 into and within the blocks 718 under the control of the navigation buttons 712 in a manner similar to that previously described with respect to FIGS. 1, 2, 4, 5, and 6, the difference being that the navigation buttons 712, the display 704, and the virtual data input device map 716 are located on the device 700.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor to receive a control signal from a navigation controller and to define a virtual user interface on a display device, and based on said control signal said processor to locate an indicator from a first location to a second location in accordance with a first navigation rule; or to locate said indicator within said second location in accordance with a second navigation rule.

2. The apparatus of claim 1, wherein said processor comprises logic to determine whether said indicator is located in a first location; and to locate said indicator in said second location according to a navigation direction provided in said control signal when said indicator is located within said first location.

3. The apparatus of claim 1, wherein said processor comprises logic to determine whether said indicator is located in said second location; to determine whether said control signal is a navigation signal or a select signal; and to locate said indicator within said second location in predetermined increments in accordance with a direction provided by said control signal when said control signal is a navigation signal; and to insert information associated with said second position of said indicator in an input field when said second control signal is a select signal.

4. The apparatus of claim 3, wherein said processor comprises logic to reposition said indicator in said first location after said information is entered in input field.

5. The apparatus of claim 1, wherein said processor comprises logic to provide said virtual user interface on said display device; to provide a virtual navigation portion in said first location; and to provide a block of virtual keys in said second portion.

6. A system, comprising:
a content device; and
a processor coupled to said content device, said processor a processor to receive a control signal from a navigation controller and to define a virtual user interface on a display device, and based on said control signal said processor to locate an indicator from a first location to a second location in accordance with a first navigation rule; or to locate said indicator within said second location in accordance with a second navigation rule.

7. The system of claim 6, wherein said content device comprises a content services device.

8. The system of claim 6, wherein said content device comprises a content delivery device.

9. The system of claim 6, wherein said processor comprises logic to determine whether said indicator is located in a first location; and to locate said indicator in said second location according to a navigation direction provided in said control signal when said indicator is located within said first location.

10. The system of claim 6, wherein said processor comprises logic to determine whether said indicator is located in said second location; to determine whether said control signal is a navigation signal or a select signal; and to locate said indicator within said second location in predetermined increments in accordance with a direction provided by said control signal when said control signal is a navigation signal; and to insert information associated with said second position of said indicator in an input field when said second control signal is a select signal.

11. A method, comprising:
receiving a control signal; and
based on said control signal:
locating an indicator from a first location to a second location in accordance with a first navigation rule; or
locating said indicator within said second location in accordance with a second navigation rule.

12. The method of claim 11, comprising:
determining whether said indicator is located in a first location; and
locating said indicator in said second location according to a navigation direction provided in said control signal when said indicator is located within said first location.

13. The method of claim 11, comprising:
determining whether said indicator is located in said second location;
determining whether said control signal is a navigation signal or a select signal; and
locating said indicator within said second location in predetermined increments in accordance with a direction provided by said control signal when said control signal is a navigation signal; and
inserting information associated with said second position of said indicator in an input field when said second control signal is a select signal.

14. The method of claim 13, comprising:
repositioning said indicator in said first location after said information is entered in input field.

15. The method of claim 11, comprising:
providing a virtual user interface on a display device;
providing a virtual navigation portion in said first location; and
providing a block of virtual keys in said second portion.

16. An article comprising a machine-readable storage medium containing instructions that if executed enable a system to receive a control signal; and based on said control signal: locate an indicator from a first location to a second location in accordance with a first navigation rule; or locate said indicator within said second location in accordance with a second navigation rule.

17. The article of claim 16, further comprising instructions that if executed enable the system to determine whether said indicator is located in a first location; and locate said indicator in said second location according to a navigation direction provided in said control signal when said indicator is located within said first location.

18. The article of claim 16, further comprising instructions that if executed enable the system to determine whether said indicator is located in said second location; determine whether said control signal is a navigation signal or a select signal; and locate said indicator within said second location in predetermined increments in accordance with a direction provided by said control signal when said control signal is a navigation signal; and insert information associated with said second position of said indicator in an input field when said second control signal is a select signal.

19. The article of claim 18, further comprising instructions that if executed enable the system to reposition said indicator in said first location after said information is entered in input field.

20. The article of claim 16, further comprising instructions that if executed enable the system to provide a virtual user interface on a display device; provide a virtual navigation portion in said first location; and provide a block of virtual keys in said second portion.
